(19) United States
(12) Patent Application Publication
(10) Pub. No.: US 2013/0308800 A1
(43) Pub. Date: Nov. 21, 2013

(54) 3-D Audio Data Manipulation System and Method

(71) Applicant: Todd Bacon, Litchfield Park, AZ (US)

(72) Inventor: Todd Bacon, Litchfield Park, AZ (US)

(21) Appl. No.: 13/843,169

(22) Filed: Mar. 15, 2013

Related U.S. Application Data
(60) Provisional application No. 61/648,914, filed on May 18, 2012.

(51) Int. Cl. H04R 3/12

(52) U.S. Cl. CPC H04R 3/12
USPC 381/300

(57) ABSTRACT

A 3-D audio data manipulation system providing a multi-dimensional audio field generated by a speaker array. The speaker array is driven by audio data and has a plurality of speakers, with each speaker having a unique physical position within the audio field. The system includes a 3-D mixing module having a plurality of fader channels. Each fader channels configured to receive input audio data. The input audio data selectable from a plurality of 3-D mixing module audio data input channels. Each fader channels further configured to provide a selectable sound intensity increase, or decrease, to the input audio data. The 3-D mixing module further provides a selectable plurality of 3-D mixing module audio data output channels for each of the plurality of fader channels. Any 3-D mixing module audio data output channel may be redirected back into a 3-D mixing module audio data input channel of the 3-D mixing module. Each of the plurality of 3-D mixing module audio data output tracks is then directed to a selectable speaker position, or plurality of speaker positions, within the speaker array to produce the audio field.

### CROSS-REFERENCE TO RELATED APPLICATION

This application claims the benefit of U.S. Provisional Application Ser. No. 61/648,914, filed on May 18, 2012, the entirety of which is hereby incorporated herein by reference.

### BACKGROUND OF THE INVENTION

1. Field of the Invention

The present invention generally relates to systems used to reproduce monophonic, stereo, and/or surround sound formats of audio sounds. More particularly, the present invention relates to an apparatus and method allowing for standard monophonic, stereo and or surround audio formats to be converted into an audio format that produces 3-D audio data presentation with both azimuth and elevation.

2. Description of the Related Art

Currently sound reproduction systems that attempt to reproduce true 3D audio have used a number of ways to achieve a certain amount of success. These techniques range from phase manipulation, use of tem or more speakers, cross talk filtering or elimination, etc. These methods at best produce a 3D sound field that either is diffused in sound quality, has a limited number of sweet spots, or allowable listener positions, i.e. you cannot sit too close to any one speaker, etc.

There are many companies attempting to achieve 3D audio in the industry each with their own approach and/or technique. Many of these companies use phase manipulation to attempt to fool the human ear into perceiving height. The problems with this technique are that the natural tonal quality is changed and no sounds can be heard directly over your head. Another technique is to use many speakers, and in some cases more than one hundred speakers are used. Another technique is to alter the actual audio mix through crosstalk cancelation. This technique results in a slightly better surround sound field but limits the listeners to five or six people in a room and is not a true 3-D experience. Yet another technique is to make each speaker perform more like an omnidirectional speaker. This technique does fill the room just as reflective speakers do, but the sounds produced cannot track the action of a movie or television show. One thing all of the prior art techniques have in common are position limitations within the audio field. The limitations range from not being able to sit too close to any one speaker and still hear 3-D, to a limitation in how many tracks or sounds can move in the 3-D space at the same time to each person hearing sounds as if they were in a different location in space.

Accordingly, it would be advantageous to provide a system and method which allows for any seat at any position within an audio hall to have a clear and multi-dimensional sound from floor to ceiling, front to back, and even behind barriers. The system should function provided no doors are closed between the listener and the audio system and speakers. The system should allow the listeners to be behind or far from the speakers and still hear a believable, clear, multidimensional sound. The invention may work well with four speakers (4.0 audio format) and other formats such as 4.1 (four speakers with subwoofer), 5.0, 5.1, 6.0, 6.1, 7.0 and 7.1 with no need for larger formats, i.e. more speakers. It is thus to such a 3-D audio data manipulation device and method that the present invention is primarily directed.

### SUMMARY OF THE INVENTION

The disadvantages of the prior art are overcome by the present invention which, in one aspect, is a 3-D audio data manipulation system providing a multi-dimensional audio field generated by a speaker array. The speaker array is driven by audio data and has a plurality of speakers, with each speaker having a unique physical position within the audio field. The system includes a 3-D mixing module having a plurality of fader channels. Each fader channels configured to receive input audio data. The input audio data selectable from a plurality of 3-D mixing module audio data input channels. Each fader channels further configured to provide a selectable sound intensity increase, or decrease, to the input audio data. The 3-D mixing module further provides a selectable plurality of 3-D mixing module audio data output channels for each of the plurality of fader channels. Any 3-D mixing module audio data output channel may be redirected back into a 3-D mixing module audio data input channel of the 3-D mixing module. Each of the plurality of 3-D mixing module audio data output tracks is then directed to a selectable speaker position, or plurality of speaker positions, within the speaker array to produce the audio field. In another aspect, the present invention includes a fader ratio lock providing a fixed ratio of sound intensity increase, or decrease, among all channels of the 3-D mixing module.

In another aspect of the present invention, the 3-D audio data manipulation system includes a reverb module. The reverb module provides a plurality of selectable reverb module audio data input channels configured to receive audio data from any selected 3-D mixing module audio data output, or input channel. The reverb module also provides a selectable time delay to each channel of audio data. The reverb module further includes a selectable plurality of reverb module audio data output channels. Any reverb module audio data output channel may be redirected back into a selectable 3-D mixing module audio data input channel of the 3-D mixing module.

In other aspects of the present invention, the reverb module provides a selectable sound intensity increase, or decrease, to each channel of audio data. The reverb module may also provide a selectable decay time to the reverb module audio data. The reverb module audio data output channel may be redirected back into a selectable reverb module audio data input channel. A plurality of time delays may be applied to a plurality of frequency ranges within each channel of audio data. A reverb mix value may be selected which relates the mix ratio of the reverb module audio data output channel with the original audio data as unprocessed by the reverb module to each channel of audio data.

In another aspect of the present invention, the 3-D audio data manipulation system includes an acoustic rain module. The acoustic rain module provides a plurality of selectable acoustic rain audio data input channels. The acoustic rain module audio data input channels are configured to receive audio data from any selected 3-D mixing module audio data output, or input channel. The acoustic rain module provides a selectable time delay function to each channel of audio data. The acoustic rain module further provides a selectable plurality of acoustic rain module audio data output channels. Any acoustic rain module audio data output channel may be redirected back into a selectable 3-D mixing module audio data input channel of the 3-D mixing module.

In other aspects of the present invention, the reverb module provides a time delay function which relates to a ceiling shape. The acoustic rain module also provides a selectable sound intensity increase, or decrease, to each channel of audio data. The acoustic rain module audio data output channel may also be redirected back into a selectable acoustic rain module audio data input channel. An acoustic rain mix value is selectable. The mix value relates the mix ratio of the acoustic rain module audio data output channel with the original audio data as unprocessed by the acoustic rain module.

In yet another aspect, the present invention provides a method of 3-D audio data manipulation. The 3-D audio data manipulation provides a multi-dimensional audio field from a speaker array being driven by audio data. The speaker array has a plurality of speakers, with each speaker having a unique physical position within the audio field. The method includes the steps of receiving input audio data into a 3-D mixing module, the 3-D mixing module includes a plurality of fader channels, each fader channels configured to receive input audio data, the input audio data selectable from a plurality of 3-D mixing module audio data input channels. Each fader channels further configured to provide a selectable sound intensity increase, or decrease, to the input audio data.

The method provides selecting from a plurality of 3-D mixing module audio data output channels for each of the plurality of fader channels. Redirecting any 3-D mixing module audio data output channel back into a 3-D mixing module audio data input channel of the 3-D mixing module. And directing each of the plurality of 3-D mixing module audio data output tracks to a selectable speaker position, or plurality of speaker positions, within the speaker array to produce the audio field. The method may also include the step of engaging a fader ratio lock, the fader ratio lock providing a fixed ratio of sound intensity increase, or decrease, among all channels of the 3-D mixing module.

In yet another aspect, the method of the present invention includes the steps of selecting a reverb module audio data input channel within a reverb module. Configuring the reverb module audio data input channels to receive audio data from any selected 3-D mixing module audio data output, or input channel. Selecting a time delay to apply to each channel of audio data within the reverb module. Selecting from a plurality of reverb module audio data output channels.

Selecting a sound intensity increase, or decrease, to apply to each channel of audio data. Selecting a decay time to apply to the reverb module audio data. Applying a plurality of time delays to a plurality of frequency ranges within each channel of the audio data. And redirecting any reverb module audio data output channel back into a selectable 3-D mixing module audio data input channel of the 3-D mixing module.

In other alternative aspects of the present invention, the method includes the step of receiving input audio data into an acoustic rain module. The acoustic rain module including a plurality of selectable acoustic rain audio data input channels. The acoustic rain module audio data input channels configured to receive audio data from any selected 3-D mixing module audio data output, or input channel. Selecting a time delay function to apply to each channel of audio data within the acoustic rain module. Selecting from a plurality of acoustic rain module audio data output channels. And redirecting any selected acoustic rain module audio data output channel back into a selected 3-D mixing module audio data input channel of the 3-D mixing module. The selected ceiling shape defining the time delay function. A selected sound intensity increase, or decrease, may be applied to each channel of audio data. And a selected acoustic rain module audio data output channel may be redirected back into a selected acoustic rain module audio data input channel.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE DRAWINGS

FIG. 1 is a schematic diagram of the elements and modules within the 3-D audio data manipulation system and method.

FIG. 2 is a front view of a 8 channel 3-D audio mixing module with complex 3-D reverb.

FIG. 3 is a front view of a 4 channel 3-D mixing module.

FIG. 4 depicts the functionality within the internal reverb processing module of the 3-D mixing module.

FIG. 5 depicts the functionality within the acoustic rain module as an available module within the 3-D mixing module.

FIGS. 6A-6D, depict the reverb decay time.

FIG. 7 depicts the functionality within the acoustic rain module as an available module within the 3-D mixing module.

FIGS. 8A-8F depict the functionality provided by the fader global ratio lock.

FIG. 9 depicts the functionality within the compressor/limiter module.

FIGS. 10A-10B depict the parameters available within the compressor/limiter module.

FIGS. 11A-11B depict the difference in the filter curve using the Q. factor to affect more or less frequencies within the parametric EQ/Filter module.

### DETAILED DESCRIPTION OF THE INVENTION

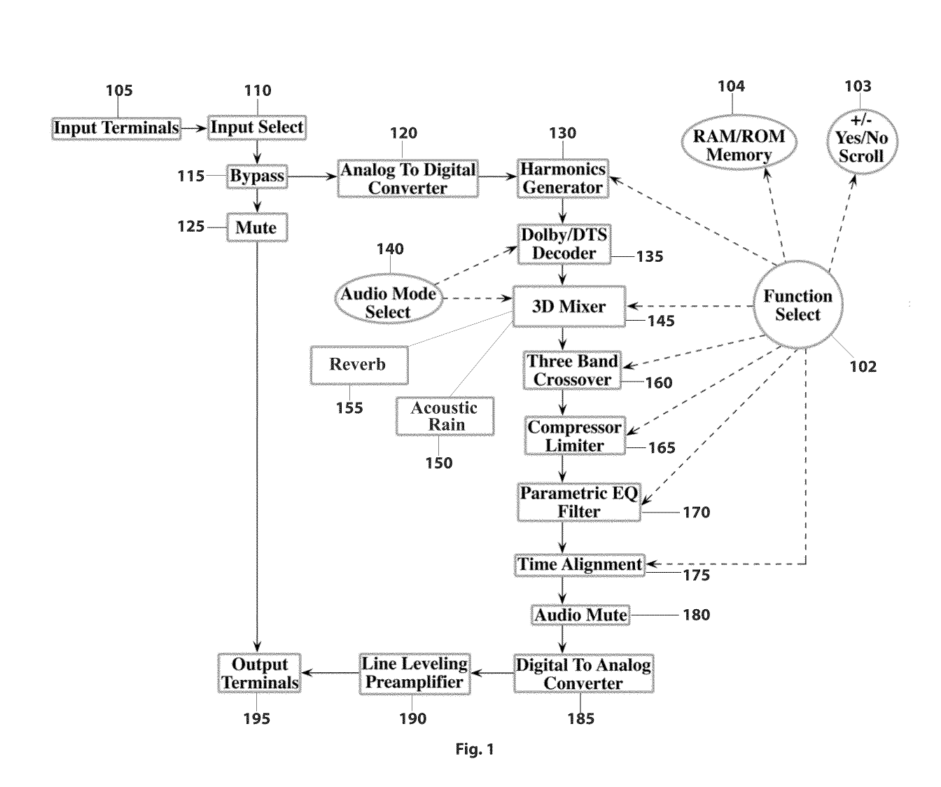

With reference to the figures in which like numerals represent like elements throughout, as depicted in FIG. 1, the 3-D (“3 Dimensional”) audio data manipulation system of the present invention comprises a variety of discrete modules. The application of each module, the order the modules are applied, as well as the application parameters within each module, to the audio signal or sound data, are selectable by the user at 102 and 103. The system is serviced by both RAM and ROM memory 104.

The system comprises audio and computer input terminals 105 provided for receipt of audio and computer generated commands as well as preset parameter audio representations. The system also comprises an analog to digital converter 120. An input select switch 110 may be controlled to select routing of audio signals to the 3-D audio data manipulation system through a bypass module 115 to the analog to digital converter, as well as turning on or off the converter 120 allowing digital signals to pass directly to the next module unaffected by the converter.

The bypass module 115 is also provided for routing an unprocessed audio signal to pass to the output terminals 195 through an audio mute switch 125. The audio mute switch may provide as much as 99 decibels (“db”) of attenuation to the unprocessed signal.

The analog to digital converter 120 is provided for converting analog audio input signals to digital for processing within the digital domain of the invention embodied in the diagram of FIG. 1. The conversion rates may be from 44.1 kHz, 48 kHz, 88.2 kHz, 96 kHz, 176.4 kHz, 192 kHz, etc. The bit rates may be from 16 bits, 20 bits, 24 bits, 32 bits to 64 bits. A bypass mode within the digital converter module may be provided to allow digital audio input signals to pass unprocessed through to the next module.

A harmonics generator 130 is provided to either generate or provide harmonic distortion to the audio signal. The harmonic distortion may provide a simulation of high quality tube and/or solid state audio preamplifiers. The harmonics generator may provide as much as 25% harmonic distortion of the second order harmonics to the audio signal in 0.25% steps. A third and fifth order harmonics generator may be added and switchable from on and off for adding harmonics that are most common when tubes are driven to a point where more distortion than typically found in acoustic music content is present. The third and fifth order harmonics may be individually controlled with a maximum of 25% each controlled in 0.25% steps. In an alternative embodiment, a second system may be provided just after this stage within the harmonics generator module that may use a germanium transistor, or a set of germanium transistors, to add a strong sense of harmonic distortion.

The harmonics generator 130 may also include a simple line leveling amplifier/attenuator to keep audio volume levels from going over the line level required for home audio devices. The line leveling amplifier/attenuator will be automatically controlled using a sensor that may monitor the audio signal using a 32 bit processing chip for extreme speed to avoid any latency problems which become obvious with audio/visual media. Line leveling may be turned off, or the maximum signal strength of the audio output may be increased, if a balanced output is connected and made active for use with third party professional grade audio amplification, recording systems, etc.

The third and fifth order harmonics may have a signal strength or volume sensor which would increase the percentage of third and fifth order harmonics when the audio signal strength is closer to maximum signal strength or volume of the audio content. The increase may be a maximum of 15% when going from an audio signal of −40 db. to 0 db. The harmonics generator may have a musical instrument input mode where the percentage increase of third and fifth order harmonics amount will change to a maximum of 25% with the same audio signal strength change and may be programmable.

A Dolby, DTS or other third party decoder 135 is provided to allow compatibility with current audio formats. The Dolby/DTS decoder may also be used to separate the dialog content from the music/sound effects tracks for easy management of volume dynamics once the audio signal is sent to the compressor limiter module. The decoder will be able to perform typical 5.1 to 7.1 formats with no more than 7.1 being required. 7.1 decoding would only be used in true 3D mode. The mode used by the converter module will be determined by the audio mode select module.

In the case of “3D converter mode”, the decoder will not exceed the 5.1 format and the 3D signal will be extracted from the front left and right audio signal with left being converted to the front/top center track and right being converted to the rear/top center track.

Dialog may be mixed into both tracks to simulate the natural acoustic interactions of voices within a real, live acoustic environment. In such a case the dialog would be less pronounced over the rear/top center track/speaker.

An audio mode select module 140 is provided to determine the audio signal path, to or through the Dolby/DTS decoder 135 to the acoustic rain 3D mixer module 145 as well as which type of decoding shall be used, if any should be used at all, on the audio signal.

When the audio mode select 140 is controlling the acoustic rain 3D mixer module 145 it is determining if an audio signal should be using the acoustic rain part of that module and if so, how it should be set as far as pre-programmed parameters for acoustic rain to be used. One example of when acoustic rain should be used is in the reproduction of classical music recorded in a live environment such as a cathedral where natural acoustic rain is most commonly experienced. Acoustic rain is most commonly experienced as the mid-high and high frequencies heard floating overhead in a cathedral during a choir performance and in the some cases a classical performance heard under a domed ceiling such as most churches have.

The different audio modes are as follows: Dolby, DTS, 3D Converter (mono, stereo, music (CD. HD), surround Dolby, surround DTS, broadcast auto select), video game, instrument input and up-sample (96 kHz, 192 kHz, 384 kHz), (20 bit, 24 bit, 32 bit and 64 bit).

There is an acoustic rain/3D mixer module 145 provided to add or enhance acoustic rain in music content or for instrument input play to greatly enhance reverberated sound and/or to convert a standard reverb unit to true 3D reverb may be provided in the mixer module. The 3D mixer section of this module is a part of the acoustic rain processing yet, it can be used without the acoustic rain active and in fact is needed for the routing of all 3D processed sound.

The 3-D mixer module 145 has functions that are much different than standard mixing boards. One such function is that the output track selection for each of the eight faders (volume controls) can be selected for unique panning Example, standard settings are seen as tracks 1&2, 3&4, 5&6, 7&8, etc. In place of that system, each track can be selected individually. For example in the 3-D mixer module of the present invention, tracks 1&3, or 1&4, 2&6, 2&7, 2&8, 3&8, may be chosen for a given channel.

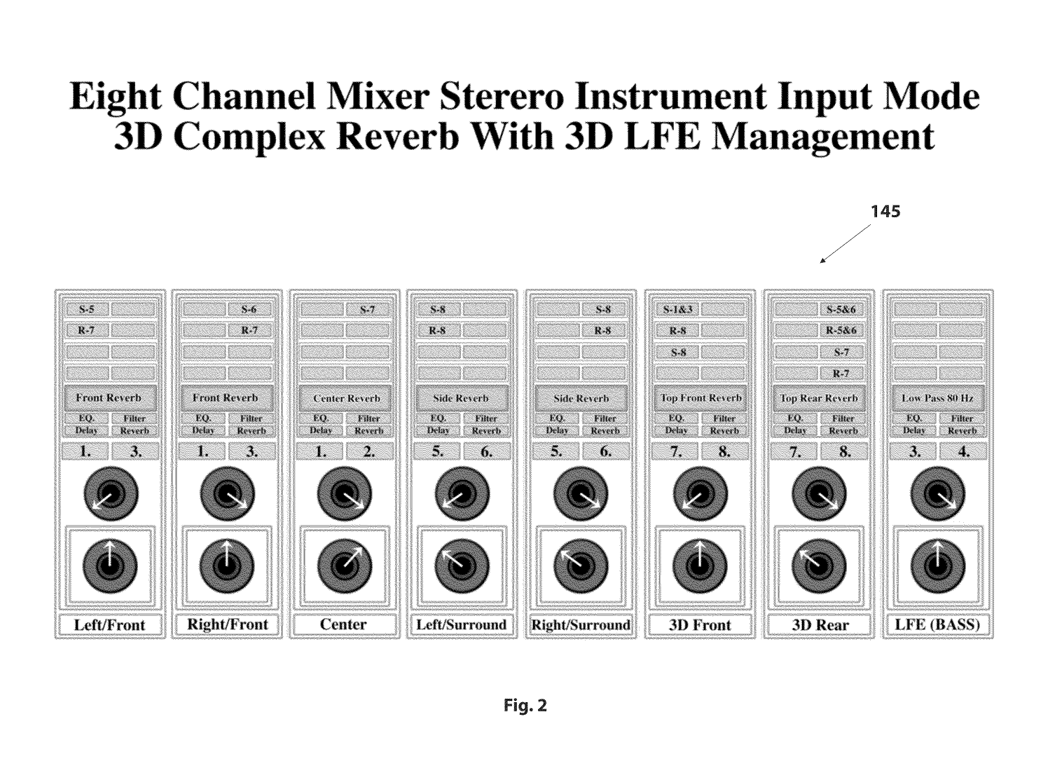

Depicted in FIG. 2 is an 8 channel 3-D mixer module 145 control. The 8 channels are fed by tracks 1&3, 1&3, 1&2, 5&6, 5&6, 7&8, 7&8, and 3&4 respectively. This track selection functionality allows for unique panning needed for two reasons. One, Dolby's type of speaker/track assignment has made most panning unusable or complex at best. Example, 1 is the left speaker, 2 is the center speaker and 3 is the right speaker. In this example simple left right panning from (1&2) is no longer possible, so the assignment must now be (1&3) for simple left to right panning The second reason for this unusual panning/track output assignment is for the reproduction, emulation or creation of realistic/natural reverbs and/or acoustic rain. In the case of reverb, a natural reverb may be reflected from many points, back toward the source and again off of the wall behind that source as well as off of the ceiling and again around the room, hall, etc.

For this reason several assignment lists are available per each fader within the mixing module. The assignment lists allow sound to be passed to one output, processed, sent to another track or location, processed by that reverb/delay parameters and on to another location such as the ceiling for complex diffusions and delays, etc. The signal may them pass to the head height speakers where the acoustic rain would blend with the direct sound as well as sound that has fewer reflections and is less therefore reverberant. Additionally, one other function allows for sound passed back to the sound track to be re-processed by the same reverb, delay, etc. This re-processed sound track is to accurately reproduce what happens in natural acoustic environments that cannot be done any other way.

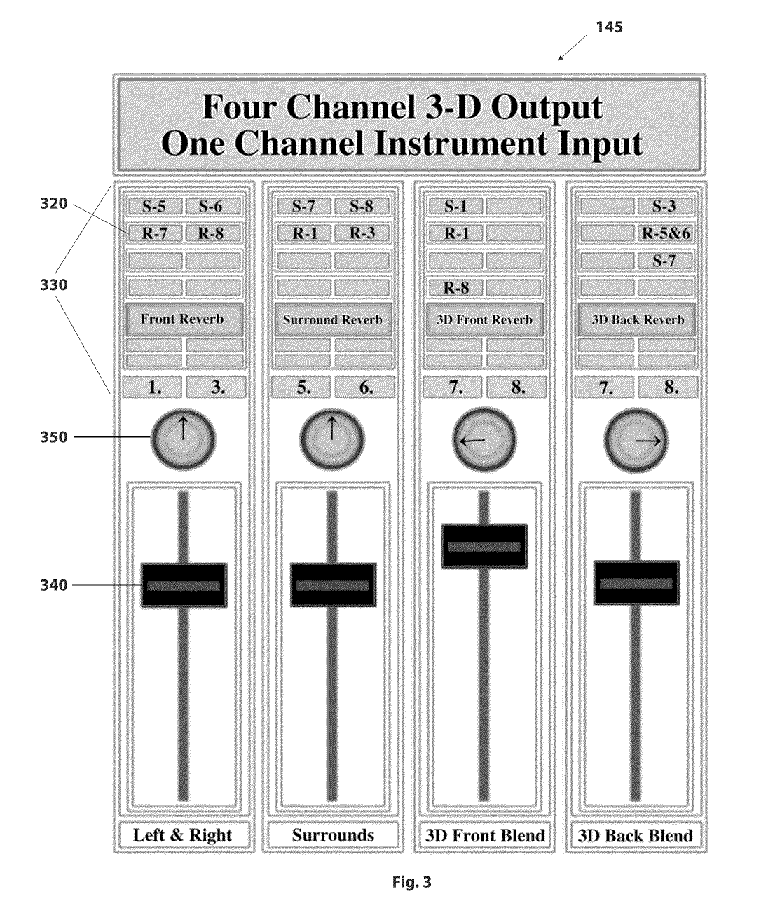

A 4 channel 3-D mixing module 145 is depicted pictorially in FIG. 3. Each channel of the mixer module 145 has the send and receive feedback assignments 320 depicted at the top of each channel. The monitoring sections 330 are divided in half with the left and right representing that channel's output assignment such as left=1 and right=3, etc. S-1 would mean sent to tract 1. R-7 would mean received from track 7. Each track which is sent to another track may be reprocessed by effects of that track. This option is selectable within the effect dialog box when that effect is open for use when adjusting the parameters of that effect. The maximum amount of times a signal may be processed is selected from once to three times.

The data showing the audio that has been received from another track is shown automatically. The tracks sent are selected by the sections showing that data by clicking or tapping on the button. A dialog box will allow the selection of the track to receive the audio as well as a mix/volume control for limiting or maximizing the volume of the sent track in relation to the audio directly coming from that tracks input.

The bottom control shown is a simple volume slider 340 and the knob above that is a simple panning knob 350. Each track may have four selectable internal effects comprising parametric EQ, filter, delay and reverb. The selectable internal effects may be separate from the other modules within the invention and be an integral part of the mixer module itself. There may be a side chain input into the mixer module channels to allow the introduction of third party effects/processing such as reverb, EQ, etc. The side chain of third party effects/processing may work as an insert into the system. In an alternative embodiment, the internal effects such as filter, parametric EQ, and delay may be contained only within the other modules shown and in that case are brought into the mixer module either in a side chain or insert type of fashion.

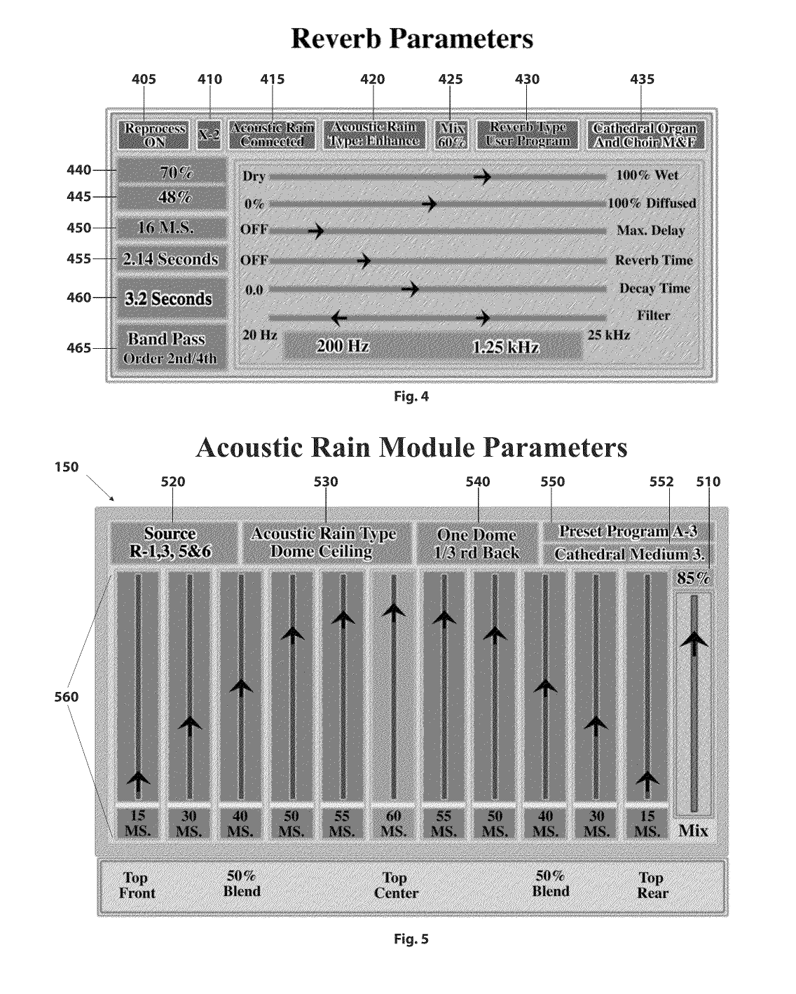

FIG. 4 depicts the internal reverb processing module 155 of the 3-D mixing module 145. The reverb module can be accessed as an internal effect within the 3-D mixing module and has the following parameters and abilities. As depicted in FIG. 4 from top left to right: reprocess 405 (On or Off), X-1, X-2 or X-3 410, the amount of times a signal may pass through the effect/processing, in this case X-2 also includes the original signal, pre or post insert information. In this example, acoustic rain is shown as connected 415. The acoustic rain may be inserted before the reverb “pre” or after the reverb “post”. The acoustic rain type 420 shown in the diagram is enhance mode. Mix 425 shown within the diagram is 60%. The next window to the right is reverb type 430. Shown within this diagram the window displays user program indicating a program within the RAM memory set by the user and not a preprogrammed setting. The next window to the right shows the actual name and/or type of program active 435. In this depiction, the window displays, cathedral organ and choir M&F, for male and female.

FIG. 5 depicts the acoustic rain module 150, which is an available module within the 3-D mixing module 145. The actual acoustic rain module is set to 85% mix 510. The acoustic rain mix value 510 and the reverb mix value 425 are different settings. The acoustic rain mix value 425 relates to its mix (ratio) with the original signal as unprocessed by the acoustic rain module. The mix value 510 within the reverb settings of the acoustic rain module is the mix of the acoustic rains total output will be allowed into the reverb module. In the case of the acoustic rain being a post reverb insert, no mix information would be shown and the mix window would read Mix N/A. Regarding mix values, in all cases where a processing or effect allows reprocessing a signal, the mix value will be the same for both audio input signals. The acoustic rain module 150 and reverb processing module 155 are individually user selectable within the 3-D mixing module.

As further depicted in FIG. 4, the side dialog windows show either the values created by the control to its right and/or the type of filtering of the low and/or high pass filter to the right as shown in the diagram of the reverb module housed within the 3-D mix module. The values/parameters of the controls are as follows.

Dry to wet 440, (mix) 0%=dry to 100%=wet, this control is performed in steps of 1.0%. The term wet and dry are used by recording and mixing engineers to describe the sound of a voice or instrument passing through a reverberation processor. The term dry refers to the sound of an instrument or voice that has no reverb or ambient signature of a hall, cathedral or room. The term wet is used to describe any instrument or voice that is heavily processed by reverb, or has lot of ambience to the sound. When a sound is said to be very wet, it has substantial reverb. When a sound is said to be dry, it has no or little reverb.

Diffusion 445, this mix of diffused to reflected sound in performed in 1.0% steps as well from 0% to 100% with 100% being completely diffused.

Delay 450, this function delays the reverb but not the clean, unprocessed sound. With the delay set to 16 milliseconds (“M.S.”) as in the example shown in the diagram, the reverb will not start until sixteen milliseconds after the dry or unprocessed sound has passed through the system. The minimum setting is off or no delay at all, and the maximum setting is 2.0 seconds.

Reverb time 455 is the amount of time the reverb is heard at the volume it is set at by the mix control with no decay in the volume. The minimum setting for this control is 1.0 milliseconds. With this control all the way to the left the reverb time is set to off. The reverb time's maximum setting is 18.0 seconds from the time it is activated or first heard. This means the delay time is not subtracted from the maximum reverb time, so 18.0 seconds is always the maximum usable reverb time.

As will be appreciated by those skilled in the art, the controls above can be used to delay audio signals only, or for creating very tight or short ambient environments. Using the diffusion control 445 along with decay time 460 can be a creative tool for subtle environments.

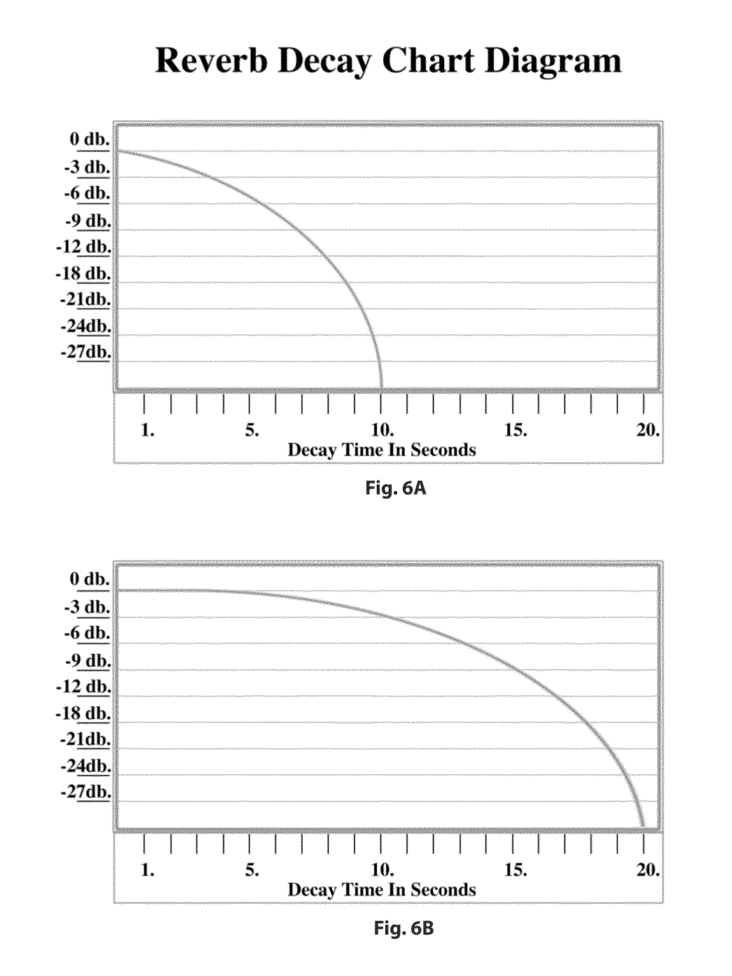

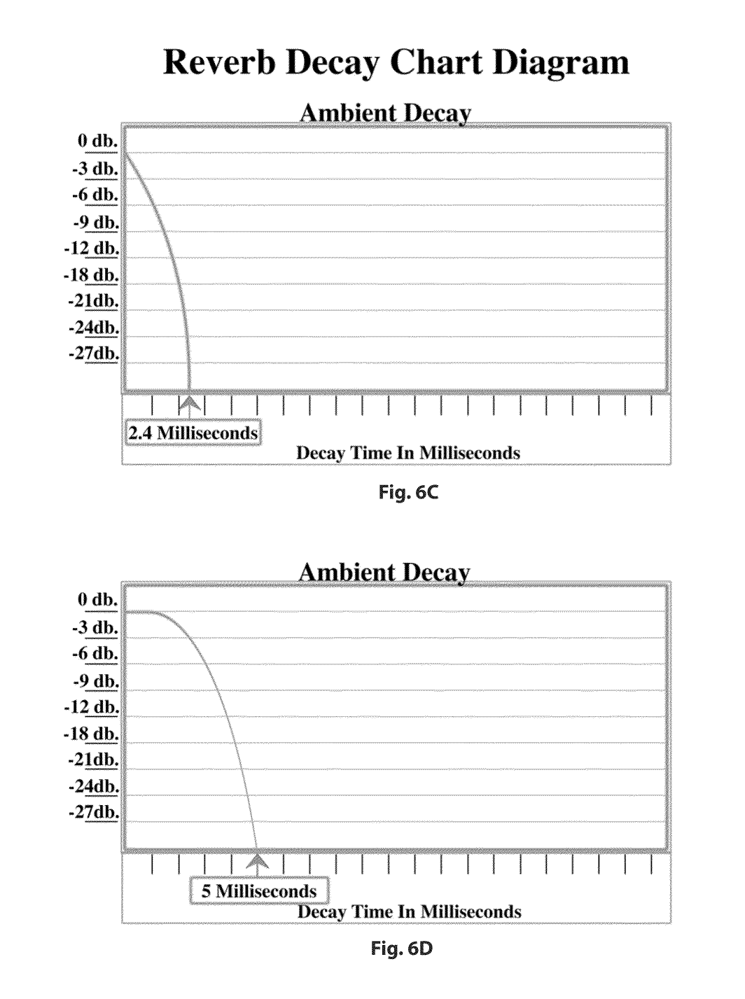

Reverb decay time 460, is a simple decay that takes effect as soon as the reverb time has been reached. As depicted in FIGS. 6A-6D, the reverb decay time begins at exactly the same volume and mix as the reverb and smoothly tappers off. As depicted in FIG. 6A, the decay time is 10 seconds. In this case the slope is always set to be a soft knee type of decay but is dependent on the time set for the decay. Therefore the decay can go from a soft knee to hard knee type. As depicted in FIG. 6B, the system maximum decay time is twenty seconds. A user can set the reverb time to the minimum (1.0 milliseconds) without being set to off, and thus create a short reverb with a long decay time. This functionality can be used in many creative ways including reverb sound drop outs, quick fades, sudden impact enhancement without leaving an obvious reverb tail to be noticed. In FIGS. 6A-6D, the fade out amount is shown as −30 db, however, it actually may be as high as −80 db., and in professional mode that value may be as high as −100 db. Ambient decay can be thought of as the decay of audible sound to inaudible sound, or below the range of human hearing. In this example, the decay is the reverb going from wet to dry. If the sound signal, or original sound, is shorter than the reverb time all of the sound heard will fade away when the decay time is reached. This can also be envisioned as a volume fading to no sound.

The filter parameter 465 only filters the sound going through the reverb and not the dry, unprocessed audio signal. In this way, the reverberant tonality can be changed in subtle or drastic ways. The filter has the ability to be any one of; a low pass, a high pass, or a band pass type depending on the frequencies selected for being filtered out before processing through the reverb. The system filter settings are from 20 Hz to 25 kHz and the increments are made in 1 Hz steps. Also, the type of slope, or order, of the filter is selectable within the system filter control.

With the low frequency select set all the way to the left, the high pass filter is off. With the high frequency select set all the way to the right, the low pass filter is off.

In another alternative embodiment, there is a dedicated delay within the acoustic rain module 150 and/or 3D mixer module 145 for creating echoes to enhance instrument input mode which may be used with reverb, etc., for effects processing. The parameters for the delay are a simple delay time setting from 0.0 M.S. to 2.0 seconds. Delay time adjustments may be made in 0.01 M.S. steps.

In another alternative embodiment, there is a feedback function for creating one, or more, echos. The echo parameter may be from 1 to 20 which would be 20 times that the sound is repeated after the initial (source) sound which is being echoed. A simple mix function is provided with parameters from 0% to 100% in 1.0% steps. A decay function is provided to give more control over the echoes allowing for a more natural or analog sounding decay type. The decay time may be sweepable in 1.0 M.S. steps.

As further depicted in FIG. 5, there is an acoustic rain function within the 3D mixer section which is accessed within the delay section as a type of delay/echo. In acoustic rain mode the delay controls change as reflected in the acoustic rain parameters diagram of FIG. 5. The parameters for the acoustic rain function may vary from delays in the milliseconds to delays shown as sample accurate choices within the delay time dialog box window. The delay times in milliseconds are from 0.0 M.S. to 100 M.S.

Far greater delay time may be provided if the acoustic rain section is sent through a channel that already has a delay on that channel. The additional delay is due to the fact that the delay using acoustic rain mode is coming in after and therefore through the previous delay. This functionality allows for longer times which are sometime found in naturally occurring acoustic rain such as caves, etc. The delay time range is the same in sample accurate mode, however it is shown in samples and therefore has a much more fine sweep through choices than the millisecond format which is sweepable in 1.0 M.S. steps.

As depicted in FIG. 5, the acoustic rain module 150 offers a mix function 510 from 0% to 100% where the selected mix ratio of unprocessed sound (0%) to only processed sound (100%) is made in 1.0% steps. The top of the dialog box depicts other system functionality from left to right, the sound source 520, the type of acoustic rain 530, the ceiling detail 540, program number and naming information 550, 552. Shown for the sound source 520 is the example R-1, 3, 5 & 6 (received from tracks 1, 3, 5 & 6). Next the system allows the type of acoustic rain 530 or ceiling type to be selected. Next the system allows a selection regarding the ceiling detail 540, and to the right of that are two dialog windows 550, 552 for the program number and name. At the very bottom of the acoustic rain's module design is a dialog window showing where the delays 560 will be placed from the front/top speaker to rear/top speaker. This allows a visual sense of the ceiling shape to be intuitive.

Within the system, pluralities of dialog boxes or windows are available within the acoustic rain module of the 3-D mixer module. The dialog boxes provide more controls than displayed within the acoustic rain control diagram and all may be selectable by simply clicking on, or tapping the details dialog box window at the bottom of the acoustic rain control surface diagram to cycle through the dialog box window choices. A double tap/click option or up/down arrows provides for better control of the dialog box window choices.

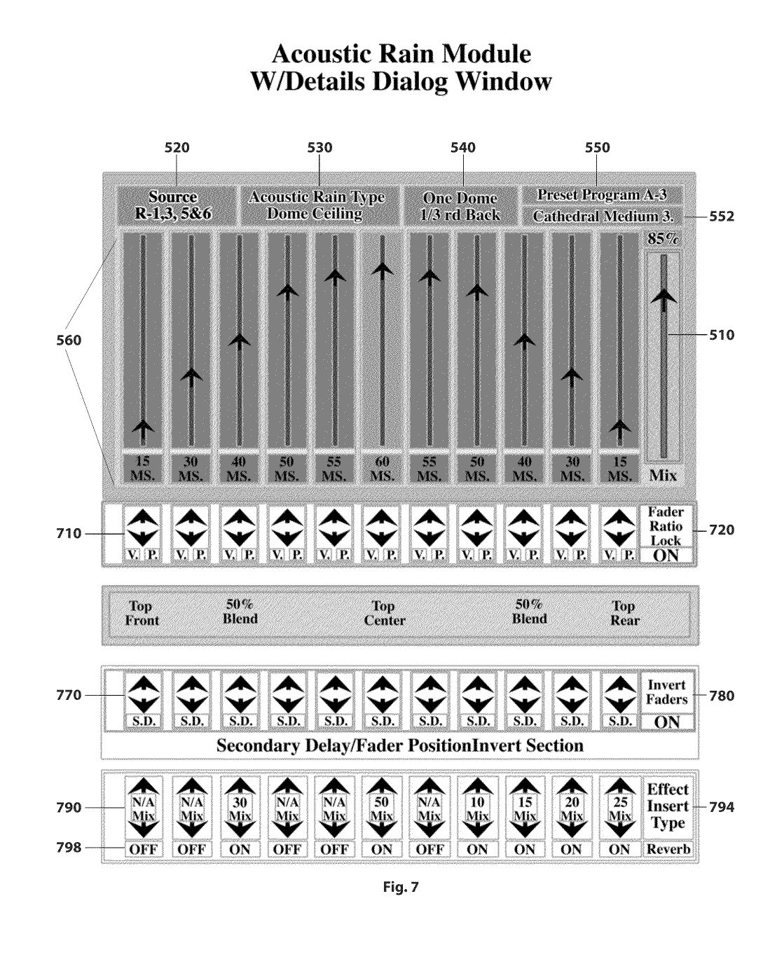

Sample dialog box window choices within the Acoustic Rain Module with Details Dialog are depicted in FIG. 7. The order is listed below from top to bottom as depicted in FIG. 7. The up and down arrows 710 may be used to control either V=volume (“V”) or P=panning (“P”) from front to rear. The V button may be used to select volume control for that individual channels delay time represented above. The P button may be used to select the panning function from front to rear channels. In the case of panning, the up button is used to send that sound to the front of the room and the down button is used to send that audio signal to the rear channel in the room. The amount is shown above in the delay amount dialog box window 560 while adjusting that parameter and may remain in view for a period of time after the panning or volume choice has been made.

The panning parameters are +100 (front) to −100 (rear) with 0 being the center. The sweep from front to rear is made in +/−1.0 steps as these numbers represent the percentage of the volume sent to that area of the room or that particular channel.

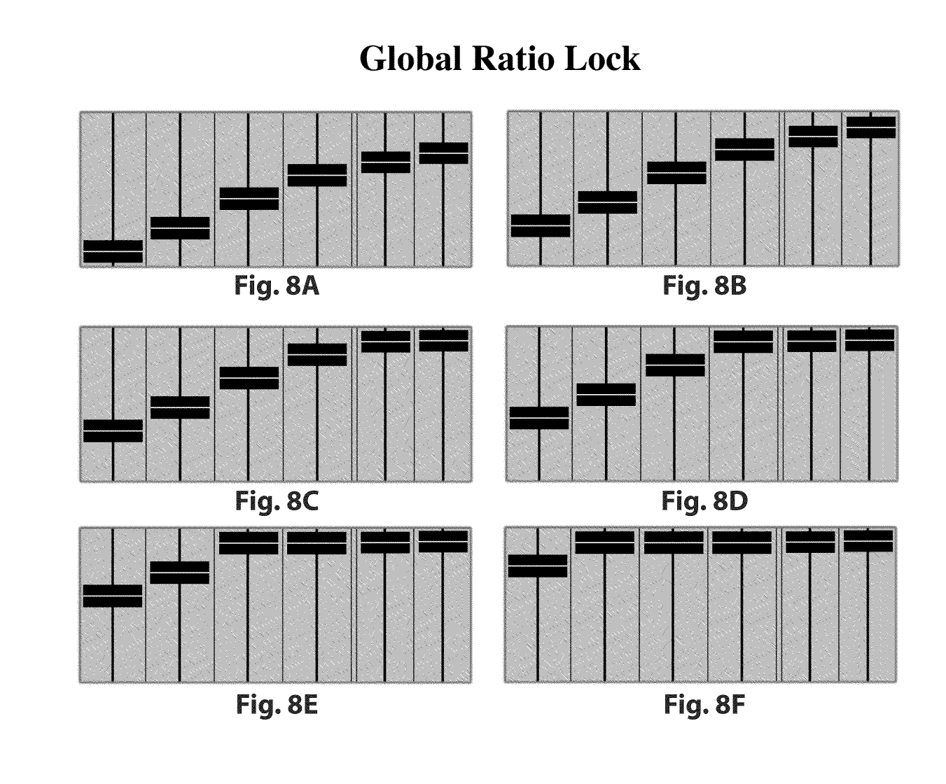

In the case of volume V, up is louder and down is softer, and the sweep is made in +/−1.0 steps from 0% to 100% or full volume. To the right in the dialog box window is a fader ratio lock option 720 with a simple on or off choice. This ratio lock 720 allows the movement of all faders to follow any fader moved to allow the same shape to be resized quickly and easily. As depicted in FIGS. 8A-8F, in the case where a maximum or minimum value has been reached by one or more faders, the maximized faders will stay at the top or bottom until such time as the other faders allow for the ratio to return. For example, FIG. 8A depicts a desired fader ratio. As depicted in FIG. 8B, with the ratio lock enabled, as the position of one fader is increased, the position of each fader is increased. Depicted in FIG. 8C, the fader for the higher frequency band has reached its peak value and remains at that setting. In FIG. 8D, the 3 highest frequency bands have reached the maximum setting, while the ratio of 3 lower frequency bands remains constant. In FIGS. 8E and 8F, the upper 4, and 5 frequency bands respectively become peaked. Starting with the fader positions of FIG. 8F, as any fader frequency position is reduced, the setting of all lower frequency faders will return to the same ratio as previously set. For example, by reducing the setting of the fader for the 4^{th} frequency band, the faders of frequency bands 1-3 will also be reduced. And the fader settings may be returned to that depicted in FIG. 8C.

As further depicted in FIG. 7, an additional dialog box window 560 shows the position of the ceiling delay points. The center is shown with a lighter grey or colored texture for quick visual reference. The center is always a 50/50 front and rear channel audio signal summed together as they would be in a room where sound blends. This center point however, may change in relation to the room and so the position of that delay point shown may not always be seen in the same position. The actual “Mix” on the acoustic rain module is the global mix for all the delay points shown as they are summed into two channels (front and rear). The delay may be selected from 0.0 M.S. to a maximum value of 80.0 M.S. in 1.0 M.S. increments.

Another dialog box window 770 shown in FIG. 7 has a switch marked “S.D.”, this is a second delay option for each area of the acoustic rain array from front to back. The second delay functionality allows for an echo or for two delay points to be heard from a certain area as they might from a dome in a cathedral. After user selection of the second delay time, the S.D. box will change to Volume for volume select of that second delay.

Should a user not select a second delay or forget to change that delay's value from the delay already used in that position, the volume option will not be shown. The up and down arrows used are to select a delay time. The parameters of the second delay are the same as those depicted for the first delay in window 560.

As further depicted in FIG. 7, there is an invert faders option 780 provided within the system and depicted by the dialog box window on the far right. The invert faders option may allow for the delay faders to be reversed. This selection may not result in numerical reversals in the sense that 60 milliseconds may not become −60 milliseconds but may become 30 milliseconds. A selection of 50 milliseconds, being half the amount of milliseconds available, will have no effect in invert mode and that fader would not move. Stated another way, the invert function is positional and refers to where a fader is in relation to the span or distance of the fader's entire physical range such as typical 100 millimeter fader found in professional audio gear.

As further depicted in FIG. 7, the system provides a control and data section for the reverb, parametric EQ, effects inserts, volume and mix controls for each delay channel, and is depicted in dialog box window 790.

The acoustic rain array has reverb, parametric EQ, or effects inserts for each individual delay channel with each channel having individual volume and mix controls. This functionality is provided due to the fact that reverb may not sound good over each and every channel or at the same volume. As will be appreciated by those skilled in the art, the front of the room where the music or audio signal source originates usually has a far less reverberant quality than the middle of the room, hall, etc. The rear of the room would typically have more reverberant quality than the middle of the same space.

As depicted in dialog box 790, the up/down arrows control the reverb mix for each delay section. The parameters for this function are between N/A which is 0% (no reverb) and 100% (full reverb). The sweep is made in 1.0% steps (100 steps+N/A, OFF or 0%). The button 798 under the mix data window is a simple on/off switch for the selection of the effect to be on or off for that delay channel. The effect insert type is functionality that chooses between reverb, delay, EQ., filter or none. The dialog box window 794 shows the selection made.

While in volume or mix adjust mode the arrow points in the large/long delay window 560 may show volumes instead and hold for a period of time after to give a better sense of the ratio of volume between each delay channel for the delay, reverb, and/or effects inserted.

When in the mode where a live music performance is being played from a CD, DVD, Blu-Ray or any form of broadcast, the user may choose not to use reverb within the acoustic rain module. In these instances, reverb will create an acoustic rain not enhance or bring out the natural acoustic rain from the environment.

When in instrument input mode, the reverb may be used to create a natural sounding acoustic rain. In addition, a side chain or insert may be provided where the effects insert type is located. This dialog will not show up as an option in the system unless an effects processing unit is plugged in and detected. When using a side chain for a third party processing unit, the user must select professional or line level. Failing to do so will not allow this function to be active. The required selection is to protect the invention from spikes in volume that may harm the system hardware. The system provides the same protection for any and all inserts and/or side chains of third party equipment.

Because there is more than one delay for each delay shown there is the ability to select lower delay times than one-millisecond. This is most useful in creating diffusion such as within the mixing board's internal reverb.

As depicted in FIG. 1, the system provides a three band crossover module 160 signal conditioning. The three band crossover module's primary use is for mono or stereo audio signals which are to be converted to 3D audio without going through or being processed by a Dolby/DTS decoder. One band is used low frequency effects (“LFE”) or subwoofer audio signal processing. This audio signal will be summed from the mono or left and right of the stereo audio signal. The default setting is 80 Hz with a 12 db. per octave slope for the LFE or subsonic audio signal. A 80 Hz high pass filter with a 6 db. per octave slope is the default when the main speakers select is set to large, and when the main speakers select is set to small a 12 db. per octave slope is employed. The three band crossover module and all others after the Dolby/DTS decoder module (unless noted) have eight discrete channels for audio.

The frequency select parameters are 40 Hz., 60 Hz., 80 Hz., 90 Hz., 100 Hz., 120 Hz., and off for the low frequency selections. The high frequency parameters are 10 kHz., 12 kHz., 14 kHz., 16 kHz., 18 kHz., and off. The high frequency parameters are most often used for live sound where typical speakers cannot handle sound above 16 kHz.

The systems high frequency select parameter/functionality allows the higher frequencies to be played over higher quality speakers or sent to dedicated high frequency speakers. The functionality is also used where speakers are bi-amped. In a bi-amped speaker the bass and midrange handled by one amplifier and a second amplifier used for just the high frequencies. The crossover slope parameters are 6 db., 12 db., 18 db., and 24 db. per octave.

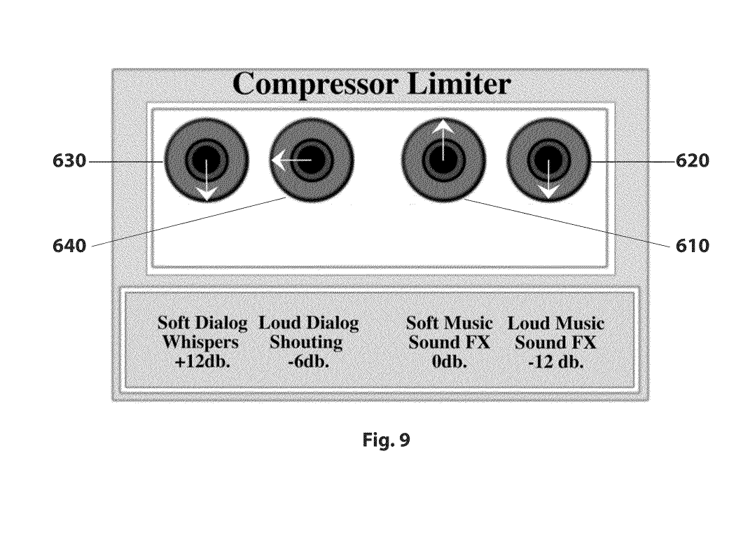

As depicted in FIG. 1, the system provides a compressor/limiter module 165 for controlling the dynamics of the audio signals of the music and/or sound effects and the dialog audio signal individually. As depicted in FIG. 9, this module has eight or more individual channels with the left, right, surround left, and surround right being controlled together with the same two faders/slider controls marked as soft Music/FX and loud Music/FX and depicted as knobs 910, 920 in FIG. 9. The center channel or dialog is controlled by a different set of controls marked soft dialog and loud dialog and depicted as knobs 930, 940 in FIG. 9.

The system may provide a simple makeup gain amplifier or line leveling amplifier within the compressor/limiter module after the compressor/limiter to ensure the signal strength stays within standard home audio or pro-audio levels. Home or pro-audio signal strength may be determined by the output terminals in use during operation such as balanced or unbalanced XLRs, TRS/14″ jacks, optical, SPDIF, etc.

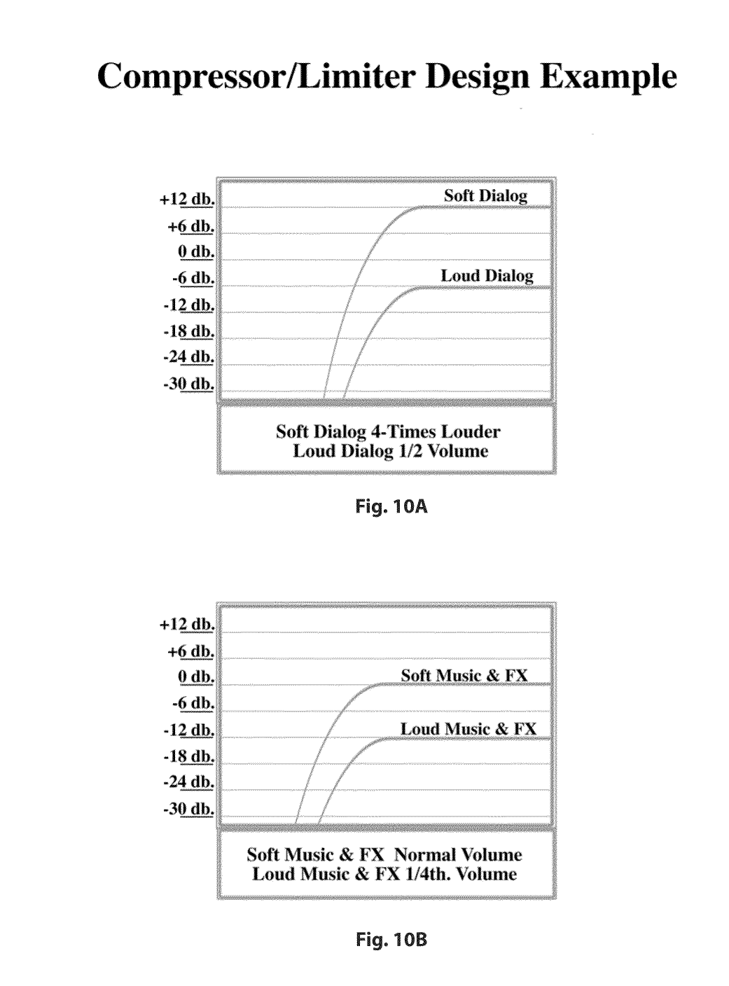

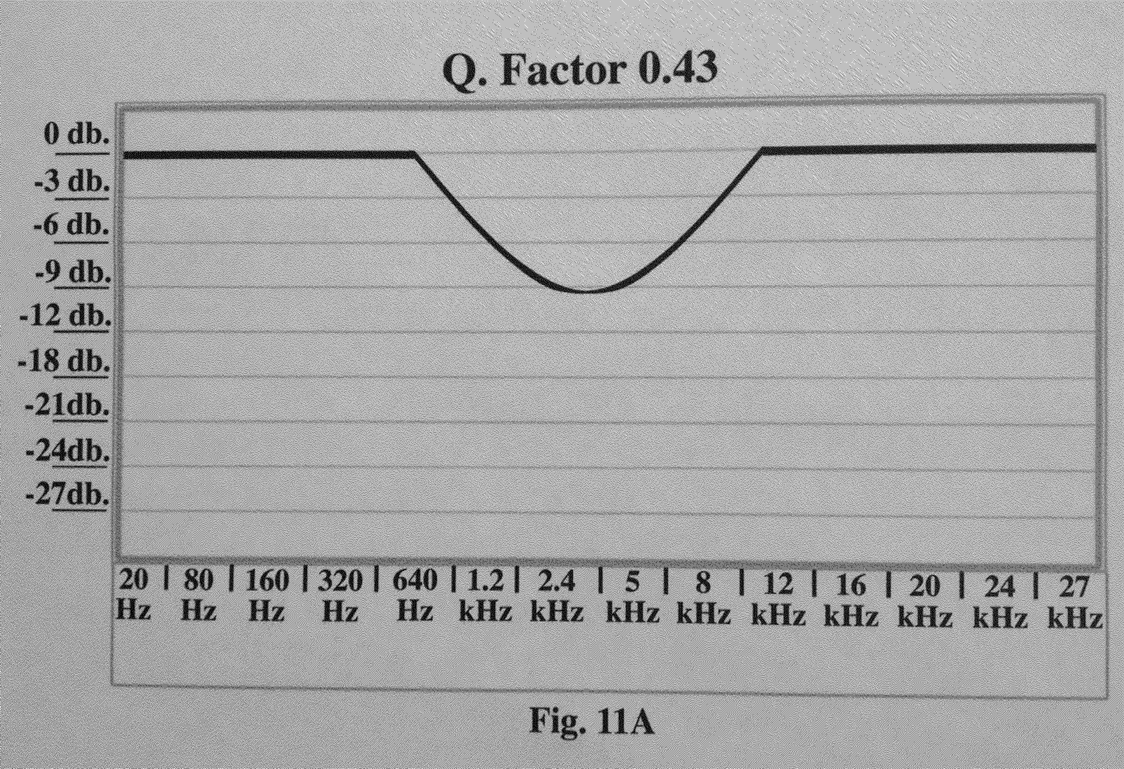

The systems compressor/limiter module parameters are depicted in FIG. 10A and 10B.

The maximum attenuation is from 0 db to −30 db. The maximum gain is +12 db, these parameters are made in +/−1 db steps. The limiting is a soft knee setting as a default and the compression is a simple gain setting that raises the volume of sounds to a level selected by the user or preset program. The system includes a line leveling amplifier/attenuator that keeps any volume increases from exceeding line or pro-audio level.

As depicted in FIG. 1, the system provides a parametric EQ/Filter module 170 to help fine tune the audio signal for room acoustic and/or to fine tune or correct poor quality audio input signals. The parametric EQ/Filter function also serves to correct problems in broadcast audio such as hum, hiss, harshness or muddy sound. The parametric EQ/Filter is an eight channel module however, the module controls all 5.1 channels at the same time with an optional switch that may allow for 7.1 control, so that all channels follow the same settings. The system includes an optional subwoofer/LFE bypass so that while correcting hum or muddy sound, the subwoofer/LFE is not affected.

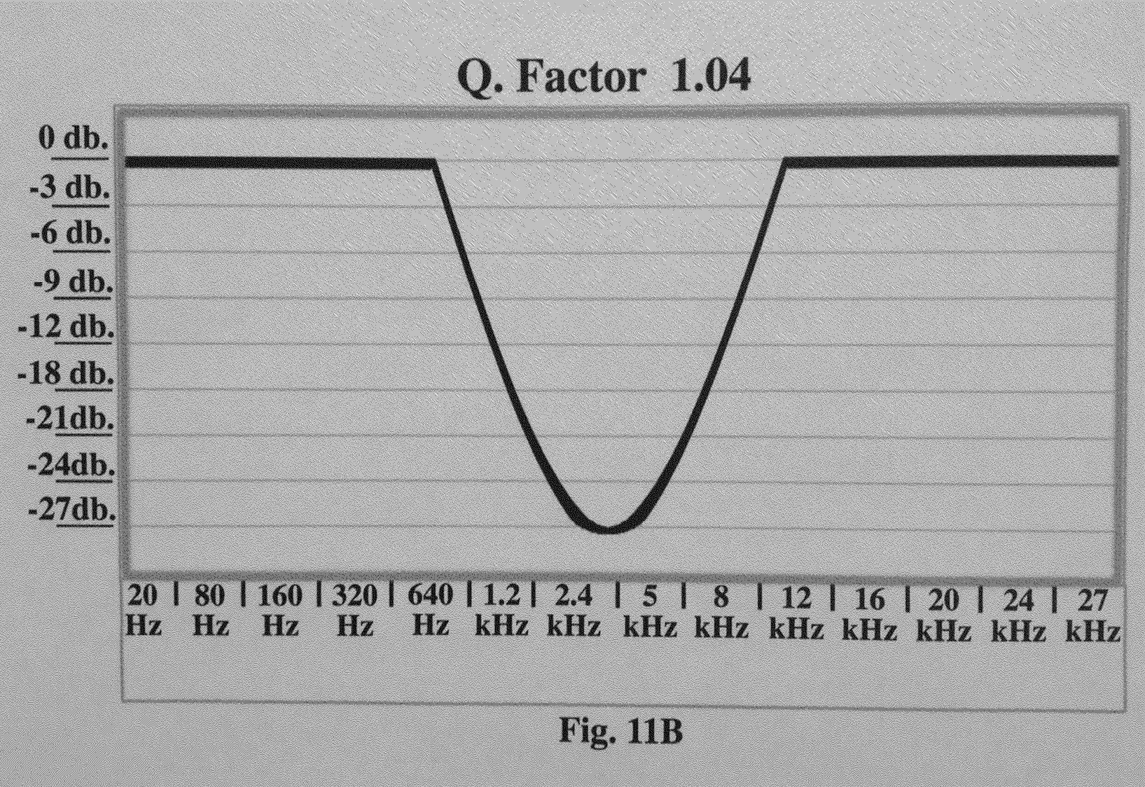

The parameters of the parametric EQ/Filter module 170 are as depicted in FIG. 11. The system provides as many as four bands of parametric EQ. Each band may have a Q factor from 0.1 to 10.0. The Q factor sweep is made in +/−0.01 steps. Each band may have the following frequency selections available per-band. High frequency 3 kHz-27 kHz, mid-high frequency 500 Hz-16 kHz, midrange 80 Hz-2 kHz and bass frequency from 20 Hz-250 Hz. All frequencies selected in the following steps: 20 Hz, 30 Hz, 40 Hz, 50 Hz, 60 Hz, 80 Hz, 100 Hz, 120 Hz, 150 Hz, 250 Hz, 500 Hz, 800 Hz, 1 kHz, 2 kHz, 3 kHz, 4 kHz, 6 kHz, 8 kHz, 10 kHz, 12 kHz, 14 kHz, 16 kHz, 18 kHz, 20 kHz, 22 kHz, 25 kHz, and 27 kHz.

A filter section is provided within the parametric EQ/Filter module 170 with a graphic or numerical representation of selectable slopes from a very wide to very narrow slope for notch filtering with a very even and smooth Q factor sweep from 0.1 to 10.0 for tonal control. The frequency selection may be from 20 Hz to 20 kHz in 1/12^{th} of an octave steps for precise/chromatic control over the tonal palate. FIG. 11 depicts the difference in the filter curve using the Q. factor to affect more or less frequencies when attenuating the sound. A sharp curve affects less frequencies whereby a wider curve affects more frequencies. The same effect can be seen for the frequencies affected when using EQ., to boost selected frequencies.

The parameters for gain reduction may be from none, or 0 db to 24 db, or extreme reduction. There may be a side chain option for the EQ/Filter to be inserted into the compressor/limiter module for use as in dampening sibilance, popping of P's, etc.

As depicted in FIG. 1, the system provides a time alignment module 175 for fine tuning the audio signal, alignment of phase or for adjustments needed to compensate for the differences in speaker placement. For example, the center speaker as it relates to the front left and right speakers, surround speakers in relation to the front speakers, the top speakers and subwoofer. The delay times may be shown in M.S., or distance in English or metric measurements. This module will be eight discrete channels. The parameters for delay may be in steps that equate to the English or metric measurements used to fine tune the speakers. Example, in common atmospheric conditions 1.0 M.S. is equal to 1.24 feet, so the sweep may be different for each measurement type. When in M.S. mode the steps will be in 1.0 millisecond increments.

As depicted in FIG. 1, the system provides an audio mute 180 for audio that has been processed by the invention embodied within the block diagram. The system also provides a mute function 125 for audio that has passed through the invention without being processed, as it would in bypass mode. The mute's attenuation may be 99 db.

As depicted in FIG. 1, the system provides a digital to analog converter 185 to convert any and all digital audio signals to analog for use with standard analog amplifiers, receivers, speakers, etc. This module may be automatically bypassed when a digital input is sensed and/or when a digital output is detected as active. The parameters of this module are the same as the analog to digital converter as far as sampling frequency and bit depth. The parameters may not be set to the same setting for the both converters if in a mode that uses up-sampling for increasing the sonic quality of the audio signal. The default in such setting will always be twice or four times the number of input signal to prevent problems that would require dithering to correct.

As depicted in FIG. 1, the system provides a line leveling amplifier/attenuator 190 to ensure that either line level or the professional level of signal strength is output to the output terminals. The signal strength output will be determined by which input is active or by audio mode select and/or by which output terminal is active.

As depicted in FIG. 1, the system provides an output terminal block 195 for audio signals and/or computer data, connection for audio output signals, etc. The output terminals may mirror those of the input terminals with respect to types of connectors. However, the output male/female type may differ.

In all of the sample modes of operation presented, three band crossover 160, compressor/ limiter 165 or parametric EQ/Filter 170 may be used. Any use of the time alignment 175 is for aligning the speakers as would be done with any surround speakers in a home theater system. The primary application in these modes for the three band crossover 160 would be if a subwoofer was desired which did not have its own crossover. In this example, the setting may be 80 Hz., at −12 db per-octave slope for the subwoofer, unless as noted before, the speakers are of poor quality, in which case the listener should follow the owner's manual for those speakers.

### Sample Mode Of Operation 7.1

### (1)

### Movies, Radio Dramas, 3D Adventure Disks, Etc.

### (CD, DVD, Blu-Ray, Broadcast, etc.)

In this sample mode the input select is set to movies/film and the choice is made between

CD, DVD, Blu-Ray etc. The next option is the up-sample mode within the analog to digital converter. The logical choice depends on the type of media such as CD, DVD, Blu-Ray or broadcast etc. In order to select the preferred up-sample rate the user must know the bit rate and sampling frequency of the media being used, such as CD's are 16 bit/44.1 kHz. In this example, the preferred choice is to simply double those numbers to 32 bit/88.2 kHz. In the case of Blue-Ray disks with a typical 48 kHz., frequency 96 kHz., or 192 kHz., would be the optimum choice. The bit rate has a maximum of 32 bits for this device which is the optimum. The harmonics generator would be set to off by default in this mode and is never on except in music modes such as live concert performance mode or instrument input.

The Dolby/DTS decoder module is defaulted to Dolby pro logic two and set for 5.1. The center channel is sent to the mixer's channel 2, by default and assigned to the center speaker output. Channel two sends that signal to both the top/front and top/rear channels to create a more natural audio interaction within the listening environment. Unless in a mode where there is no center channel. The volume of the top/front dialog is 3 db., less than the center channel and the top/rear dialog (once received by that channel) is set to 9 db., less than the front center channel.

The left signal is sent to channel 1., as a default and is then sent to the top/front channel 6., while the right is sent to channel 3., as the default and then sent to the top/rear channel 7., and through the acoustic rain sub-module within this module. The acoustic rain module may be turned off while still allowing the left channel's source audio signal to pass to the top/front channel ready to be processed. In this mode the audio going to the top/front and top/rear speakers is filtered of any frequencies below 40 Hz., with a slope of −12 db., per-octave. The top/front channel has its parametric EQ set to increase 20 kHz by a +6 db., gain with a Q factor of 1.0 while the top/rear channel has an increase of +6 db., at 20 kHz with a Q factor of 0.79. This is to emulate the high frequency interactions with ceiling corner boundaries as well as the entire surface of the ceiling. In this mode, the acoustic rain module is on but with rather subtle setting in both volume and delay times. This is so that any interactions only become obvious in live acoustic environments such as caves, castle interiors, etc., while allowing overhead sound to pass through at a noticeable volume that has not been processed by the acoustic rain portion of this module.

The settings for the acoustic rain portion of this module for this mode are defaulted as follows: From left to right (top/front to top/rear) the delay settings are 4.0 M.S., 6.0 M.S., 12.0 M.S., 18.0 M.S., 24.0 M.S., center 32.0 M.S., 24.0 M.S., 18.0 M.S., 16.0 M.S., 14.0 M.S., 8.0 M.S. The volume for these points are set to the same value −6 db., with the master mix set to 40%.

The master mix volume may be set higher or lower to personal taste and for the best sound for the particular movie, etc., chosen. The differences in the way a movie, etc. was mixed and/or mastered changes the acoustic rain module's interactions, so it is difficult to say the preferred mode of operation for this volume in a definitive way. The panning for each delay channel is as follows, (top/front) −100, −89, −76, −65, −50, center 0, +50, +65, +76, +89, +100 (top/rear).

The three band crossover is set to off as the Dolby/DTS decoder will handle the distribution of audio frequencies except for the acoustic rain module. None of the other modules that typically require settings by the user are needed after this module, so no settings beyond this point are required. The only exception may be if a movie has wild dynamics (jumps in volume) which can be set to taste. The same can apply for EQ/filtering.

### Sample Mode Of Operation

### (2)

### Mono To Stereo Converter

When the system is operating as a mono to stereo converter, the volume calibration for the acoustic rain or overhead channels has two optimum settings. For a more dramatic effect it is preferred to seek a 1 db, increase when the overhead channels are active. For a subtle amount of 3D audio that you only hear during dramatic moments it is preferred to seek a 0.5 db, volume increase when the overhead channels are active. A pink noise audio sample may be provided within the system ROM for easy calibration.

When a mono mode is selected in the audio select mode module the acoustic rain/3D mixer module has the following additional settings. Before any other effects or processing within the virtual mixing board, there will be a delay on the front left channel (channel 1). The delay time will be 0.5 M.S. and the mix will be 100%. If the mono signal is set to be output to surround channels and/or the overhead channels the same delay setting will be used on the surround left channel.

In addition to the delay on channel 1, both the right and left channels will have separate EQ/filtering settings. The left channel or channels in the case of surround sound channels being active will be set as follows, 20 Hz., −3 db., with a Q factor of 0.82, 40 Hz +5 db, Q 0.47, 525 Hz., +2.4 db, Q 0.66, 12 kHz., −1.4., db, Q 0.88, 20 kHz., −8.4 db, Q 0.65. The right channel or channels setting is as follows, 40 Hz., −4.4 db, Q 0.46, 525 Hz., −2.4 db, Q 0.65, 12 kHz., +5.9 db, Q 0.31, 20 kHz., +5.2 db, Q 0.55.

### Sample Mode Of Operation (3)

### For Music

The preferred mode of operation for classical music from stereo CD that has a minimum amount of ambient information such as acoustic rain recorded or captured is the following.

In this example, they system is using a 6.0 setup. Stated another way, the system is using left, right, left surround, right surround, top/front and top/rear speakers. If a subwoofer is used, it is always preferred to have the low pass filter or to have the subwoofer itself set to accept no signals higher than 80 Hz., with at least a −12 db., per-octave slope. If the speakers used with the system are inexpensive and of low quality the listener must follow the instructions of the speaker manufacturer. In this example we are assuming that no surround signal is provided and that the delays and filters will take over the task of creating a natural surround sound. There is no use (in this mode) of the center channel as it lessens stereo separation.

Input select mode is set to music (CD) and 6.0 is selected. The converter is automatically on with this setting and the option to up-sample may be chosen. In this example preferred mode of operation is to set the up-sample to 32 bit/88.2 kHz output. The harmonics generator is set to second order harmonics at 12%, 3^{rd} order at 5% and 5^{th} order at 5%. There is no decoder used in this example. As depicted in FIG. 5, the acoustic rain/3D mixer is set as follows. Left and right volume −5.5 db, left and right surrounds at −6.5 db. The acoustic rain module volume is set as follows; from left to right 0 db, −2.4 db., 0 db, −3.8 db, −0.4 db, center −8 db, −6.6 db, −3.8 db, −0.6 db, −0.8 db, and 0 db.

As depicted in FIG. 5, the delay settings for these same acoustic rain channels are left to right, 2.1 M.S., 6.3 M.S., 12.7 M.S., 21.1 M.S., 31.7 M.S., center 50.8 M.S., 31.7 M.S., 21.1 M.S., 12.7 M.S., 6.3 M.S., and 2.1 M.S. This combination is referred to as “Center Dome Mode.” In this mode due to the lack of ambience recorded it is preferred to add a small amount of reverb as follows, left to right reverb on/off settings, off, off, off, off, on, center on, on, on, on, and on. In this mode we have two different reverb settings with the shortest being used on the channel just left of the center, the center, and the next two channels. Those reverb settings are as follows, mix 38%, diffused 45%, delay 16 M.S., reverb time 0.1 M.S., decay time 1.3 seconds, low pass filter 947 Hz., at a −12 db., slope per-octave. The next three channels to the right are heard at the rear of the room and are therefore longer and have a longer delay time and a different low pass frequency filter point selected and a higher amount of diffusion. The reverb setting for these three channels are as follows, mix 38%, diffused 78%, delay 24 M.S., reverb time 0.1 M.S., decay time 2.4 seconds and low pass is set to 850 Hz., at −12 db. per-octave slope. The panning for the acoustic rain module in this mode is as follows, from left to right, −100, −81, −65, −59, −32, Center, +32, +59, +65, +81, and +100. The master mix is set to 100%.

The preferred mode for instrument input, though highly subjective, is set to default as a short reverb and so use the same setting as above except for the reverb which is as follows; Front left and right reverb are set as follows, mix 45%, diffused 30%, delay 16 M.S., reverb time 0.1 M.S., decay time 3.4 seconds, low pass filter 1.5 kHz at −12 db. slope. Surround sound speakers reverb is set as follows, mix 50%, diffused 55%, delay 32 M.S., reverb time 50 M.S., decay time 2.4 seconds, low pass filter 650 Hz., at −12 db., per-octave slope. The acoustic rain module uses the same setting as listed in the music (CD) mode above.

### Sample Speaker Configurations

The 5.1 speaker setup is the same as used in most home theater speaker configurations having a front left and right, a center channel, two surround channels and a subwoofer. Two additional satellite speakers are required for 3D, although as few as four speakers may be used to achieve 3D audio. Using four speakers the setup would be two standard stereo speakers plus the additional two speakers for 3D audio. The two additional speakers are placed both center, front and rear above head height, angled downward between 20 and 45 degrees towards the center of room.

While there has been shown a preferred embodiment of the present invention, it is to be understood that certain changes may be made in the forms and arrangement of the elements and steps of the method for 3-D audio data manipulation without departing from the underlying spirit and scope of the invention.

What is claimed is:

1. A 3-D audio data manipulation system, the system providing a multi-dimensional audio field from a speaker array, the speaker array having a plurality of speakers, each speaker having a unique physical position within the audio field, the speaker array driven by audio data, the 3-D audio data manipulation comprising:
a 3-D mixing module, the 3-D mixing module comprising a plurality of fader channels, each fader channels configured to receive input audio data, the input audio data selectable from a plurality of 3-D mixing module audio data input channels, each fader channels further configured to provide a selectable sound intensity increase, or decrease, to the input audio data;
the 3-D mixing module further comprising a selectable plurality of 3-D mixing module audio data output channels for each of the plurality of fader channels;
wherein any 3-D mixing module audio data output channel may be redirected back into a 3-D mixing module audio data input channel of the 3-D mixing module; and
wherein each of the plurality of 3-D mixing module audio data output tracks is directed to a selectable speaker position, or plurality of speaker positions, within the speaker array to produce the audio field.

2. The 3-D audio data manipulation system of claim 1, further comprising a fader ratio lock, the fader ratio lock providing a fixed ratio of sound intensity increase, or decrease, among all channels of the 3-D mixing module.

3. The 3-D audio data manipulation system of claim 1, further comprising:
a reverb module, the reverb module comprising a plurality of selectable reverb module audio data input channels; the reverb module audio data input channels configured to receive audio data from any selected 3-D mixing module audio data output, or input channel;
the reverb module providing a selectable time delay to each channel of audio data;
the reverb module further comprising a selectable plurality of reverb module audio data output channels; and
wherein any reverb module audio data output channel may be redirected back into a selected 3-D mixing module audio data input channel of the 3-D mixing module.

4. The reverb module of claim 3, wherein the reverb module provides a selectable sound intensity increase, or decrease, to each channel of audio data.

5. The reverb module of claim 3, wherein the reverb module provides a selectable decay time to the reverb module audio data.

6. The reverb module of claim 3, wherein the reverb module audio data output channel may be redirected back into a selectable reverb module audio data input channel.

7. The reverb module of claim 3, wherein a plurality of time delays may be applied to a plurality of frequency ranges within each channel of audio data.

8. The reverb module of claim 3, wherein an reverb mix value is selectable, the reverb mix value relates the mix ratio of the reverb module audio data output channel with the original audio data as unprocessed by the reverb module to each channel of audio data.

9. The 3-D audio data manipulation system of claim 1, further comprising:
an acoustic rain module, the acoustic rain module comprising a plurality of selectable acoustic rain audio data input channels; the acoustic rain module audio data input channels configured to receive audio data from any selected 3-D mixing module audio data output, or input channel;
the acoustic rain module providing a selectable time delay function to each channel of audio data;
the acoustic rain module further comprising a selectable plurality of acoustic rain module audio data output channels; and
wherein any acoustic rain module audio data output channel may be redirected back into a selectable 3-D mixing module audio data input channel of the 3-D mixing module.

10. The acoustic rain module of claim 9, wherein the selected time delay function relates to a ceiling shape.

11. The acoustic rain module of claim 9, wherein the acoustic rain module provides a selectable sound intensity increase, or decrease, to each channel of audio data.

12. The acoustic rain module of claim 9, wherein a selected acoustic rain module audio data output channel may be redirected back into a selected acoustic rain module audio data input channel.

13. The acoustic rain module of claim 9, wherein an acoustic rain mix value is selectable, the acoustic rain mix value relates the mix ratio of the acoustic rain module audio data output channel with the original audio data as unprocessed by the acoustic rain module.

14. A method of 3-D audio data manipulation, the method providing a multi-dimensional audio field from a speaker array, the speaker array having a plurality of speakers, each speaker having a unique physical position within the audio field, the speaker array driven by audio data, the 3-D audio data manipulation method comprising the steps of:
receiving input audio data into a 3-D mixing module, the 3-D mixing module comprising a plurality of fader channels, each fader channels configured to receive input audio data, the input audio data selectable from a plurality of 3-D mixing module audio data input channels, each fader channels further configured to provide a selectable sound intensity increase, or decrease, to the input audio data;
selecting from a plurality of 3-D mixing module audio data output channels for each of the plurality of fader channels;
redirecting any selected 3-D mixing module audio data output channel back into a selected 3-D mixing module audio data input channel of the 3-D mixing module; and
directing each of the plurality of 3-D mixing module audio data output tracks to a selectable speaker position, or plurality of speaker positions, within the speaker array to produce the audio field.

15. The 3-D Audio Data Manipulation method of claim 14, the method further comprising the step of engaging a fader ratio lock, the fader ratio lock providing a fixed ratio of sound intensity increase, or decrease, among all channels of the 3-D mixing module.

16. The 3-D Audio Data Manipulation method of claim 14, the method further comprising the steps of:
selecting a reverb module audio data input channel within a reverb module;
configuring the reverb module audio data input channels to receive audio data from any selected 3-D mixing module audio data output, or input channel;
selecting a time delay to apply to each channel of audio data within the reverb module;
selecting from a plurality of reverb module audio data output channels;
selecting a sound intensity increase, or decrease, to apply each channel of audio data;
selecting a decay time to apply to the reverb module audio data;
applying a plurality of time delays to a plurality of frequency ranges within each channel of the audio data; and
redirecting any selected reverb module audio data output channel back into a selected 3-D mixing module audio data input channel of the 3-D mixing module.

17. The 3-D Audio Data Manipulation method of claim 14, the method further comprising the steps of:
receiving input audio data into an acoustic rain module, the acoustic rain module
comprising a plurality of selectable acoustic rain audio data input channels; the acoustic rain module audio data input channels configured to receive audio data from any selected 3-D mixing module audio data output, or input channel;
selecting time delay function to apply to each channel of audio data within the acoustic rain module;
selecting from a plurality of acoustic rain module audio data output channels; and
redirecting any acoustic rain module audio data output channel back into a selected 3-D mixing module audio data input channel of the 3-D mixing module.

18. The method of claim 17, wherein the time delay function selected relates to a ceiling shape.

19. The method of claim 17, wherein a selected sound intensity increase, or decrease, is applied to each channel of audio data.

20. The method of claim 17, wherein a selected acoustic rain module audio data output channel is redirected back into a selected acoustic rain module audio data input channel.
